(19) United States
(12) Patent Application Publication
(10) Pub. No.: US 2009/0143917 A1
(43) Pub. Date: Jun. 4, 2009

(54) Residential Environmental Management Control System Interlink

(75) Inventors: Dindo Uy, North Hollywood, CA (US); David B. Nibler, Sonoma, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Zodiac Pool Systems, Inc., Moorpark, CA (US)

(21) Appl. No.: 12/255,554

(22) Filed: Oct. 21, 2008

Related U.S. Application Data
(60) Provisional application No. 60/981,778, filed on Oct. 22, 2007.

(51) Int. Cl. G05B 15/00; G05D 23/00

(52) U.S. Cl. 700/277; 236/51

(57) ABSTRACT

Various ways of expanding the capability, practicality and/or convenience of residential environmental management systems are contemplated. In one embodiment, a residential environmental management system may include a first master control, a second master control and an interlink operably connected to the first and second master controls. The system may further include a user interface that is operably connected to the interlink.

### RELATED APPLICATIONS

This application claims the benefit under 37 C.F.R. § 119(e) to U.S. Provisional Patent Application No. 60/981,778, filed Oct. 22, 2007, and entitled “Residential Environmental Management Control System Interlink;” the entire disclosure of which is incorporated herein by reference. This application is related to U.S. patent application Ser. No. ______ (Attorney Docket No. 189660/US/2), filed concurrently herewith, which claims the benefit of U.S. Provisional Patent Application No. 60/981,785, filed Oct. 22, 2007, and entitled “Residential Environmental Management Control System with Sprinkler Control Module,” the entire disclosures of which are incorporated herein by reference. This application is also related to U.S. Provisional Patent Application No. 61/015,562, filed Dec. 20, 2007, and entitled “Residential Environmental Management Control System with Automatic Adjustment,” the entire disclosure of which is incorporated herein by reference.

### TECHNICAL FIELD

The present disclosure relates to environmental management systems. More specifically, the present disclosure relates to an interlink for residential environmental management control systems and interlinked systems.

### BACKGROUND

Commercial and residential systems and devices are known for controlling pools, spas and associated water features. Other systems and devices are known for separately controlling other residential environmental management systems, such as security systems, outdoor lighting systems or automatic sprinkler systems. Residential environmental management systems are typically powered systems that include user interfaces that allow a user to program various functions and view system status.

### BRIEF SUMMARY

As describe further below, various ways of expanding the capability, practicality and/or convenience of residential environmental management systems are contemplated. The approaches contemplated herein particularly address various design constraints and practical considerations involved with residential environmental management systems.

In one embodiment, a residential environmental management system may comprise a first master control, a second master control and an interlink operably connected to the first and second master controls. The system may further comprise a user interface that is operably connected to the interlink.

In one embodiment, the system may include a housing for the interlink and at least one of the master controls. In such an embodiment, the housing may provide a convenient, practical and/or technically advantageous installation for the interlink.

In one embodiment, an interlink for connecting a plurality of master controls to a user interface may be provided. The interlink may include a plurality of interfaces configured to operably connect to a corresponding plurality of master controls. The interlink may further include at least one interface configured to operably connect to a common user interface.

In various embodiments, methods of using a single user interface to control and/or program a plurality of master controls may be provided. Such methods may involve connecting a plurality of master controls to a single or common user interface and operating the single or common user interface to selectively control and/or program one or more of the master controls.

While multiple embodiments are disclosed, still other embodiments of the present disclosure will become apparent to those skilled in the art from the following Detailed Description, which shows and describes illustrative embodiments of the invention. As will be realized, the present disclosure is capable of modifications in various aspects, all without departing from the spirit and scope of the present disclosure. Accordingly, the drawings and detailed description are to be regarded as illustrative in nature and not restrictive.

### BRIEF DESCRIPTION OF THE DRAWINGS

FIG. 1 is a block diagram depicting an installation of a plurality of residential environmental management systems.

FIG. 2 is an overview of a residence including various environmental systems to be controlled.

FIG. 3 is a flowchart illustrating an overview of operations that may be involved with installing and/or expanding a residential environmental management system.

FIG. 4 is a perspective view depicting an example of a user interface multiplexer or interlink configured to operably connect to two residential environmental management systems and to a user interface.

FIG. 5 is a schematic diagram depicting an example of an installation of two residential environmental management systems, a single user interface and a user interface multiplexer or interlink.

FIG. 6 is a perspective view depicting the user interface multiplexer or interlink of FIG. 4.

FIG. 7 is an example of a circuit diagram of the user interface multiplexer or interlink of FIG. 4.

FIG. 8 is an example of a series of displays that may be provided by the user interface for enabling the interlink.

FIG. 9 is an example of a series of displays that may be provided by the user interface for labeling the interlink.

FIG. 10 is an example of a series of displays that may be provided by the user interface for labeling the individual master controls.

FIG. 11 is an example of a series of displays that may be provided by the user interface for operation of one of the master controls.

### DETAILED DESCRIPTION

In general, a residential environmental management control system may comprise a master control, which may be configured to be operably connected to various other systems and/or devices to control such systems and/or devices. For example, the master control may include a plurality of outputs, via which control signals and/or programming instructions may be provided to connected systems. The controlled systems and/or devices may include various pool and/or spa systems, sprinkler systems, lighting systems, security systems, etc., or devices related to such systems. In other words, the residential environmental management control system may be configured to control any system or device related to a residential environment.

Although such a residential environmental management control system is scalable by expanding its functions by connecting systems/devices thereto, it may be desirable to provide more than one residential environmental management control system for certain applications. For example, a residential application may include one or more logical divisions, such as front yard and back yard, which would be advantageously controlled separately, e.g., as a separate zone.

By installing more than one residential environmental management control system, logical control may be established. Further, practical wiring, plumbing and/or other installation details may be employed for the one or more logical divisions, which may reduce installation costs, reduce system complexity, facilitate maintenance and/or increase safety. Installing a single residential environmental management control system, for example, for a large-scale residential application may be impractical and/or costly.

For example, the design of residential environmental management control systems differs fundamentally from commercial installations. A commercial installation is typically designed from the ground up to be suitable for the particular application. On the other hand, residential installations are designed to be suitable for a wide variety of applications, that is, different homes with varying layout and/or systems to be controlled. Residential installations take advantage of the fact that each home will generally have a basic layout and/or number of systems to be controlled. Thus, a single master control unit or a limited number of variants may be designed to address most residential needs.

This fundamental difference is evident in the costs and business competitiveness of such systems. On the commercial side, the costs may be quite high, hundreds of thousands of dollars or more, as the management system is designed for the particular job, and the competitive marketplace may be defined primarily by the reputation of the designer. On the residential side, costs are typically much lower, ranging from less than a thousand dollars to a few thousand dollars, and the competitive marketplace may be defined primarily by the cost and reputation of the products.

From a competitive standpoint, residential environmental management control systems thus may be designed to be suitable for most residential applications, controlling the basic cost of the systems by limiting the capability and/or capacity of the systems to what is typically required. For example, a residential environmental management control system may be designed to have several different master control models, including one configured to control a pool or a spa, a second configured to control both a pool and a spa using shared equipment, and a third configured to control a pool and a spa using separate equipment. Each of the master control models may have a predetermined capability or capacity to control other residential environmental systems, for example, via a predetermined number of auxiliary outputs. Such an approach may provide a certain amount of flexibility to suit a large number of residential applications without a need to design a wide range of master control models, which may unduly increase costs and reduce competitiveness.

Thus, for a residential application, a plurality of residential environmental management control systems may be installed when the particular application requires more capacity and/or capability than is provided by the master control models available. However, although installing a separate residential environmental management control system for each logical division may provide some distinct advantages, the user may not wish to interact with a separate user interface for each residential environmental management control system. Such inconvenience and/or complexity may be unacceptable to the user, who, as a result, may opt for the more complex and/or costly installation of a single residential environmental management control system.

One solution is to provide a single or common user interface for controlling multiple residential environmental management control systems. For example, in the case of two residential environmental management control systems installed for a residence, the single or common user interface may allow the user to control both systems, for example, by toggling between the two systems. The single or common user interface may provide displays that represent the logical divisions and allow the user to select which system(s) to control and/or program (e.g., one system or a desired combination of systems).

Providing a single or common user interface for multiple residential environmental management control systems may be made possible by providing a user interface multiplexer or interlink that allows the single or common user interface to control a plurality of residential environmental management control systems.

In addition to allowing logical divisions of an installation to be provided with separate residential environmental management control systems, the user interface multiplexer or interlink may allow the capabilities of an existing or new installation to be expanded by including more than one residential environmental management control system. Because such systems typically have a finite number of outputs or a maximum capability, an installation may be provided with twice the capability by including two residential environmental management control systems, for example.

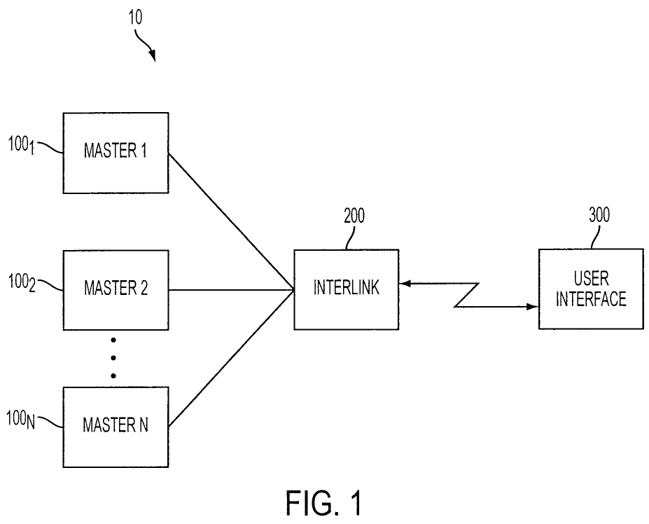

As contemplated in various embodiments, an installation 10 of a plurality of residential environmental management systems 100₁, 100₂, through 100_{N} is illustrated by the block diagram of FIG. 1. Each of the residential environmental management systems 100₁, 100₂, through 100_{N} may be operably connected to an interlink 200. The operable connection may be wired or wireless, as appropriate or desired. In some applications, wired connections may be desired for reliability and/or to avoid electrical interference. In other applications, wireless connections may be desired, for example, to avoid complex or undesirable wiring.

The interlink 200 may be operably connected to a common user interface 300, which may be configured to allow a user to input commands or program instructions for operating the residential environmental management systems 100₁, 100₂, through 100_{N}, either individually or in various combinations. As discussed above, the user interface 300 may be a single user interface configured to control or operate the residential environmental management systems 100₁, 100₂, through 100_{N}. It should be understood that more than one user interface 300 may be employed, for example, as redundant access points for the user, allowing a user interface 300 to be installed at multiple locations, as appropriate or desired. However, the installation 10 is configured to provide control or operation of all of the residential environmental management systems 100₁, 100₂, through 100_{N} via the user interface(s) 300, i.e., via common user interface(s).

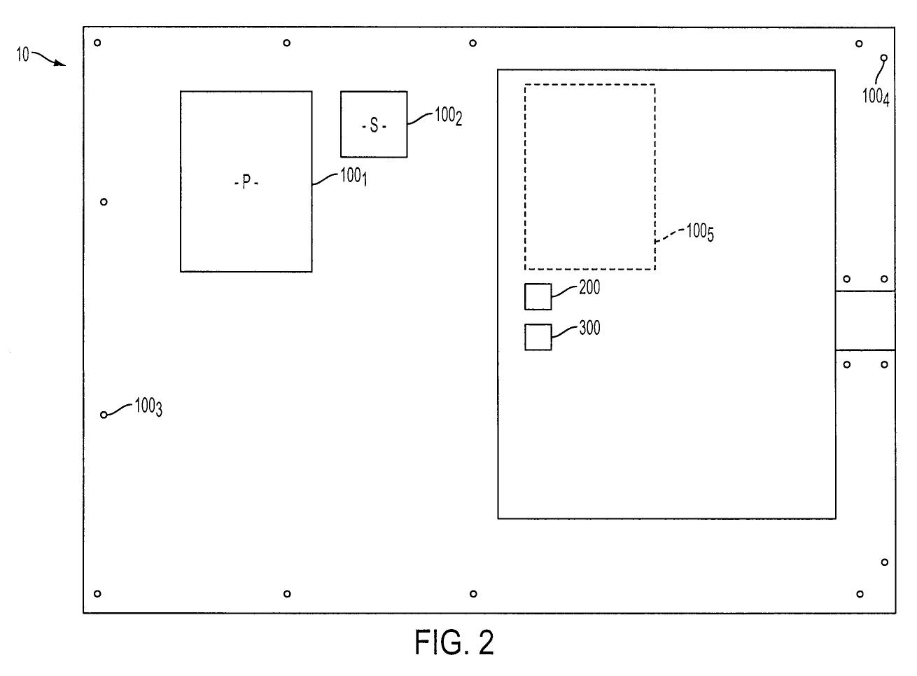

FIG. 2 is an overview of a residence including various residential environmental systems to be controlled, such as a pool P, a spa S, backyard lighting, frontyard lighting, and an indoor pool IP. It should be understood that these residential environmental systems are only examples and not exclusive of other systems that may be controlled. It should also be understood that the installation 10 of residential environmental management control systems 100₁, 100₂, 100₃, 100₄, 100₅ shown in FIG. 2 may be implemented in various ways. For example, each of the residential environmental management control systems 100₁, 100₂, 100₃, 100₄, 100₅ may be separate master controls that are placed in communication with the interlink 200. As discussed above, the interlink 200 may be placed in communication with the common user interface 300, such that control and/or programming of each of the residential environmental management control systems 100₁, 100₂, 100₃, 100₄, 100₅ may be performed from the common user interface 300.

It should be understood that implementing the installation 10 with individual master controls for each system to be controlled will typically not be the most cost-effective approach. However, depending on the capabilities and/or capacities of the master controls used or available for a given installation, a wide variety of configurations may be envisioned using the interlink 200.

For example, residential environmental management control systems 100₁ and 100₂ may be implemented as a single master control configured to control both the pool P and the spa S. Such a master control may also be configured to control the backyard lighting via as auxiliary output rather than another master control 100₃. A second master control configured to control the indoor pool IP may be employed to implement the residential environmental management control systems 100₄ and 100₅, for example, with the frontyard lighting controlled via an auxiliary output of the second master control. This approach may allow a logical division between frontyard and backyard systems, and/or between outdoor and indoor systems by having the frontyard lighting controlled via an auxiliary output of the first master control. As discussed above, this approach may be appropriate when the master controls are each designed to control only a single pool and/or spa.

Not only may the approach described herein allow a relatively high degree of flexibility of configuration using a single model or only a few models of master controls with limited capability and/or capacity, the approach may facilitate expansion of an existing installation, without requiring a complete redesign. In other words, the addition of another pool and/or spa, and/or the addition of residential environmental systems beyond the capability/capacity of an existing installation may readily be accommodated by the addition of another master control and an interlink. Depending on the user interface employed for the existing installation, the common user interface may or may not need to be added.

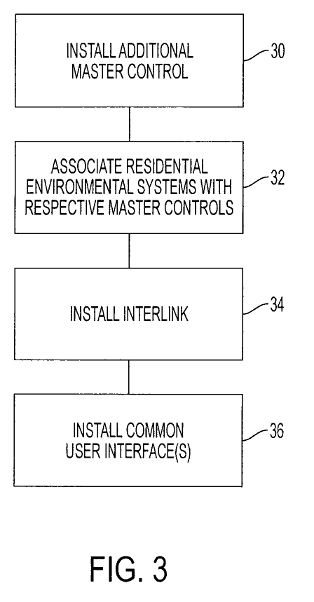

Thus, as illustrated in the flowchart of FIG. 3, expanding an existing installation may be a relatively simple process. When a need for expansion of an existing installation arises, or a need for an installation beyond the capacity and/or capability of a single master control installation for that matter, an additional master control may be installed in operation 30. Such an operation may be repeated as needed for the particular installation. Thus, whether expanding an existing installation or providing a new installation, one or more operations of installing an additional master control may be performed.

Then, the residential environmental systems may be associated with respective master controls in operation 32. This may be done in any suitable manner, for example, leaving preexisting connections between residential environmental systems and the preexisting master control(s) intact and establishing connections between added residential environmental system(s) and added master control(s), or establishing one or more logical divisions for control between the master controls.

In operation 34, one or more interlinks may be installed, depending on the number of master controls employed for the installation. Any suitable arrangement of networking the master controls via the interlink(s) may be employed, such as daisy chaining the master controls.

If necessary, a common user interface may be installed in operation 36. It should be understood that the preexisting user interface of an installation being expanded may be employed, as appropriate or desired. Also, where each master control includes a user interface, the operation 36 may involve configuring one or more of such user interfaces to operate as a common user interface.

From the foregoing, it should be understood that the approach described herein may provide a modular solution to residential installations and/or expansion of installations. This should not be understood to exclude application of the approach described herein to commercial applications, but rather to distinguish from ground-up design typical for commercial installations. As described above, the approach described herein allows for a limited number of master control models or designs with a limited or predetermined number of outputs to be employed for a wide variety of installations and/or expansions without requiring design specific to the installation.

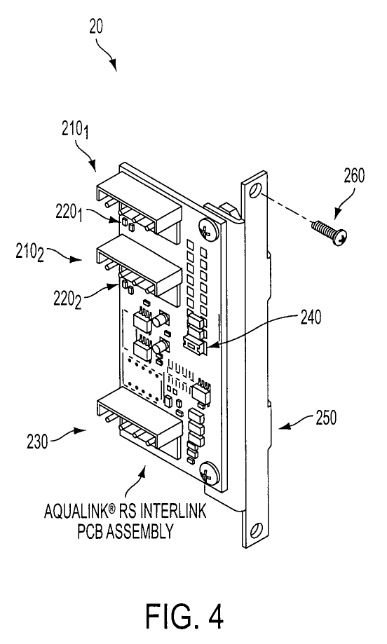

An example of a user interface multiplexer or interlink 20 configured to operably connect to two residential environmental management systems and to a user interface is depicted in FIG. 4. The interlink 20 may comprise a printed circuit board (PCB) with suitable circuitry for communicating with a desired number of residential environmental management systems and a desired number of user interfaces.

In the example shown, the interlink 20 may include a plurality of interfaces 210₁, 210₂, configured to operably connect to master controls of corresponding residential environmental management systems. The interfaces 210₁, 210₂ may be configured to receive a connector, a cable, wiring or the like from the corresponding master control. Alternatively, for wireless communication with the master controls, the interfaces 210₁, 210₂ may be operably connected to or replaced by one or more suitable wireless transceivers. Wireless communication signals specific to each master control may be employed in any suitable manner, as appropriate or desired, whether known or hereafter developed.

The interlink 20 may include status indicators 220₁, 220₂ for each of the interfaces 210₁, 210₂ to indicate, for example, that the corresponding master control is operating or operating properly, that the corresponding interface is operating or operating properly, or that the corresponding master control or interface is selected for control or programming via the user interface. In some embodiments, the interlink 20 may include a switching button or input 240. The switching button or input 240 may be pressed to manually choose (toggle) which master control is routed to the common user interface. This may be provided as a convenience to an installer or a service technician to rapidly switch among the various master controls.

In the example shown, the interlink 20 may include an interface 230 configured to operably connect to a single or common user interface. The interface 230 may be configured to receive a connector, a cable, wiring or the like from the user interface. Alternatively, for wireless communication with the user interface, the interface 230 may be operably connected to or replaced by a suitable wireless transceiver, as discussed above.

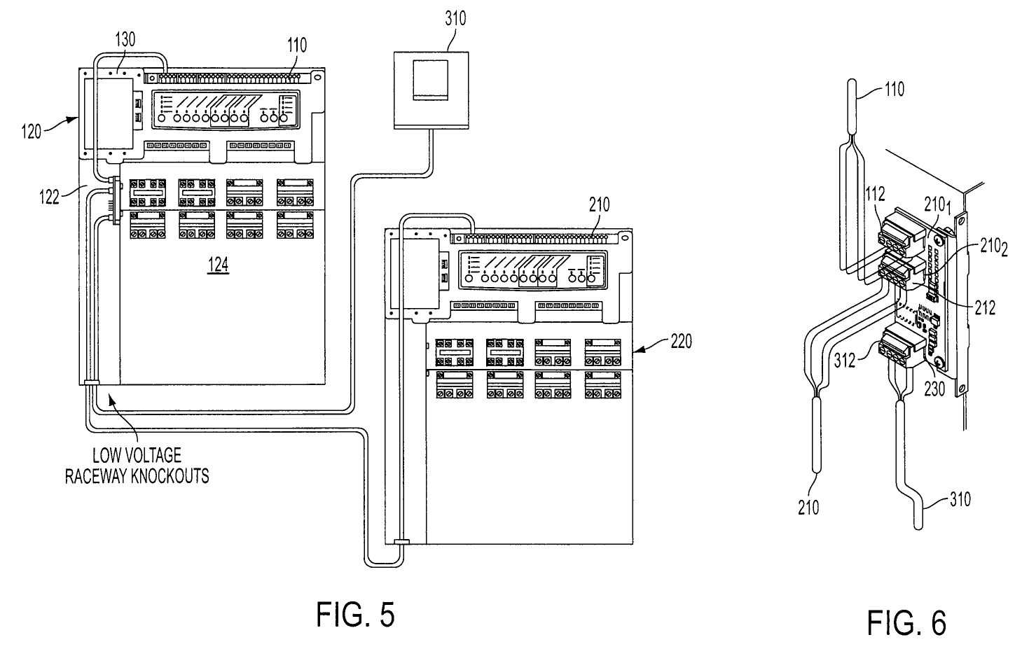

The interlink 20 may be embodied as a module, for example, to facilitate its addition to an existing installation or residential environmental management system. Thus, the interlink 20 may be provided with a mounting bracket 250 and screws 260 or other suitable mounting hardware configured to install the interlink 20, for example, within a housing that contains a residential environmental management system. This may provide a practical and convenient location for the interlink 20, not requiring a separate housing and facilitating operable interconnection with one of the plurality of residential environmental management systems of the installation. Further, shielding benefits of the housing and/or close proximity to one of the plurality of residential environmental management systems may be obtained. A particular mounting arrangement for the interlink 20 is illustrated in FIG. 5.

In this example, a first master control 110 is disposed within a first housing 120 and a second master control 210 is disposed within a second housing 220. The housings 120, 220 may be located near each other or remotely, as appropriate or desired, for example, based on the locations of the respective systems and/or devices the first and second master controls 110, 210 are configured to control.

The interlink 20 may be disposed within and mounted to a structural component of the first housing 120, for example. As illustrated, the first housing 120 may include a low-voltage raceway 122 that is separated from a high-voltage area 124, which may include relatively high-voltage power or input/output terminals for the systems and/or devices to be controlled by the first master control 110. For example, the high-voltage area may be where connections are made to power relays that are used to turn on and turn off load devices such as pumps, lights, and the like.

Similarly, although not illustrated, the interlink 20 may be mounted to a daughter card bracket 130 of the first master control 110, thus disposing the interlink in the low-voltage area in which the first master control 110 is disposed. In either arrangement, the interlink 20 may be shielded from the high-voltage area to avoid interference with its communications. Also, either arrangement takes advantage of the existing enclosure and power supply of the particular master control for the interlink 20.

The interlink 20 may be operably connected to the first master control 110 via a wire or cable 21 and to the second master control 210 via a wire or cable 22. It should be understood that any suitable connection that enables communication of control signals may be employed, including wireless technologies. It should also be understood that the first and second master controls 110, 210 may include suitable interfaces for wired connection or suitable transceivers for wireless communication, depending on the mode employed.

Similarly, the interlink 20 may be operably connected to a common user interface 310, either wired or wirelessly. In some embodiments, wirelessly may be preferred, for example, to enable a remote location for the common user interface 310 without construction for adding wiring to an existing residence.

FIG. 6 illustrates the interlink 20 of FIG. 5 in more detail. In particular, FIG. 6 illustrates wired connections for the first and second master controls 110, 210 and the common user interface 310 using connectors 112, 212, 312, respectively, which are configured to engage or mate with the respective interfaces 210₁, 210₂, 230.

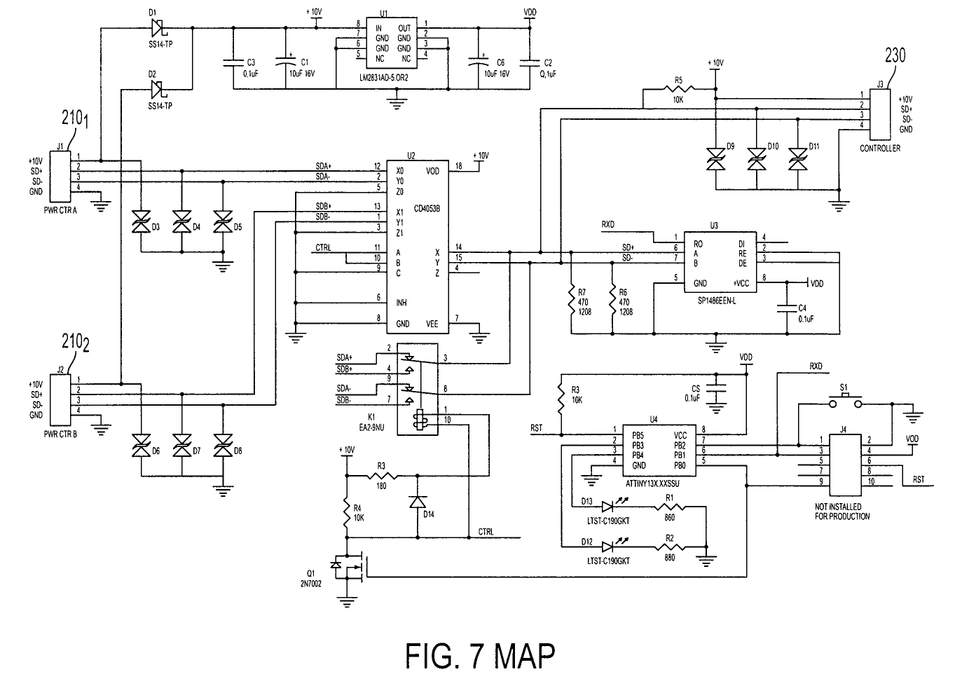

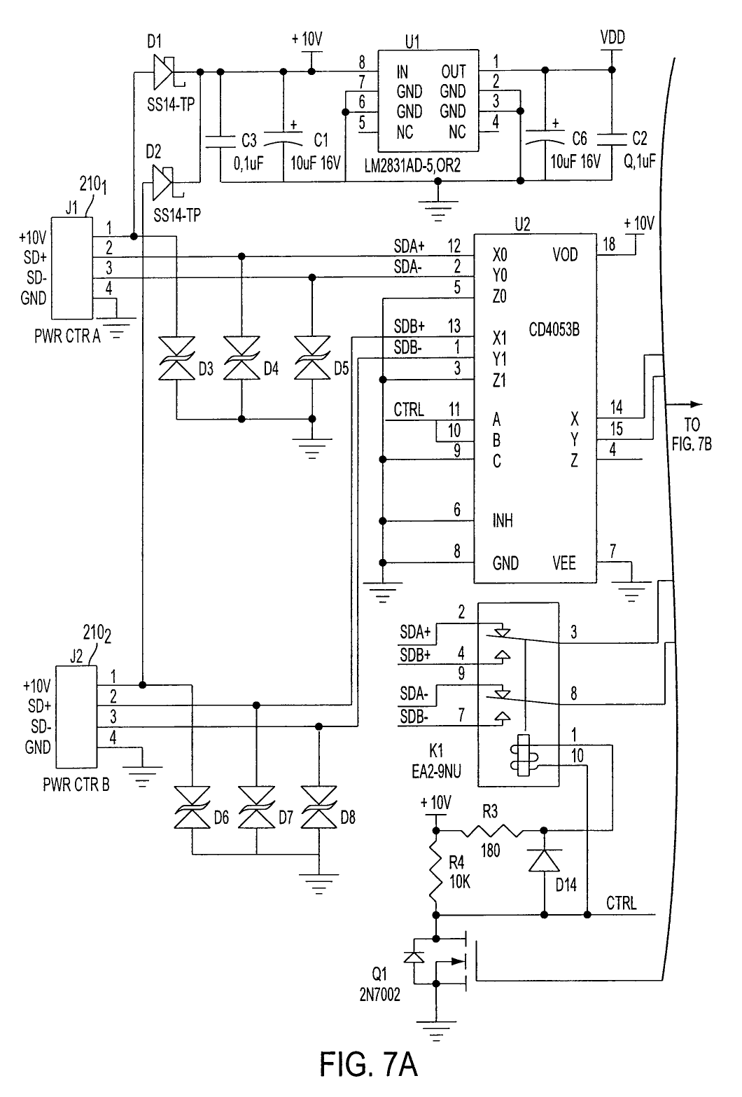

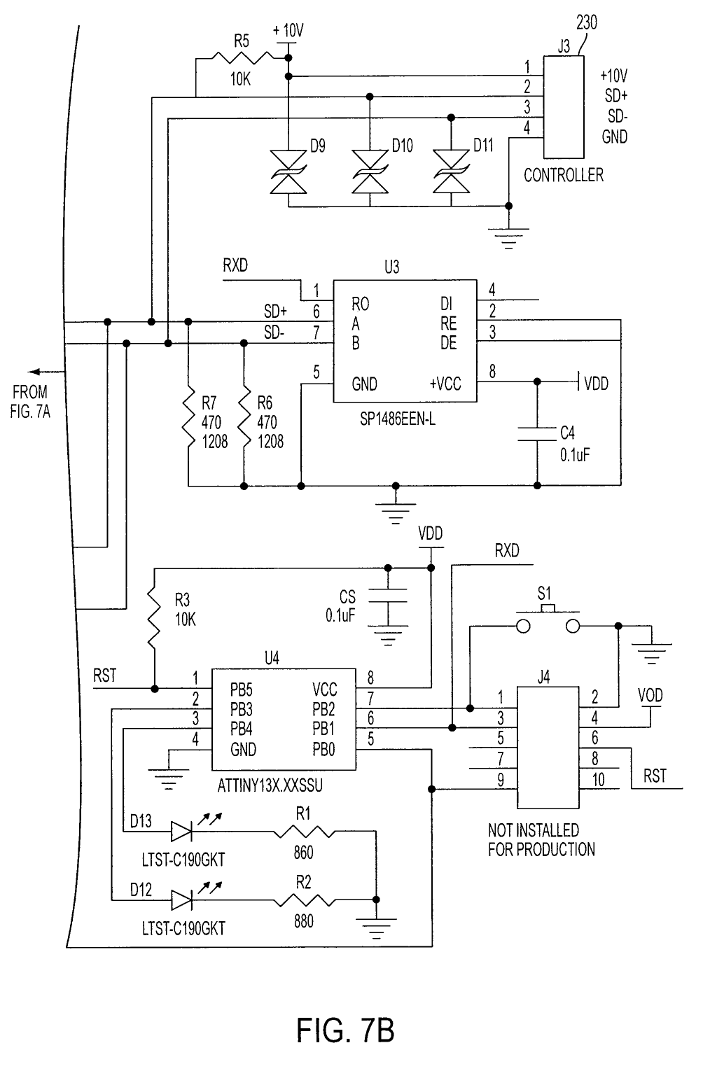

FIG. 7 is an example of a circuit diagram of the user interface multiplexer or interlink 20 of FIG. 5. It should be understood that this circuit diagram illustrates only one possible configuration that may be employed. As such, the circuit paths and/or the elements shown may be modified or replaced as appropriate or desired for a given application.

Various methods of using a single user interface to control and/or program a plurality of master controls are contemplated as will be evident from the description provided above. Such methods are not limited to connecting a plurality of master controls to a single or common user interface and operating the single or common user interface to selectively control and/or program one or more of the master controls, but encompass various installation methods and other methods of use as well.

For example, a method may involve providing a first master control, a second master control, a user interface and an interlink. Communication links may be established between the first master control and the interlink, between the second mater control and the interlink, and between the user interface and the interlink. The communication links may be established by a wired or wireless connection, as appropriate or desired.

Once the communication links are established, the user interface may be configured to assign a name to each master control. In some embodiments, the name may be determined by user input to the user interface. In either case, the name assigned to each master control may appear on the user interface when the user interface is configured to interact with the respective master control. Thus, the user interface may be configured to switch between the master controls via the interlink and to identify the master controls by name.

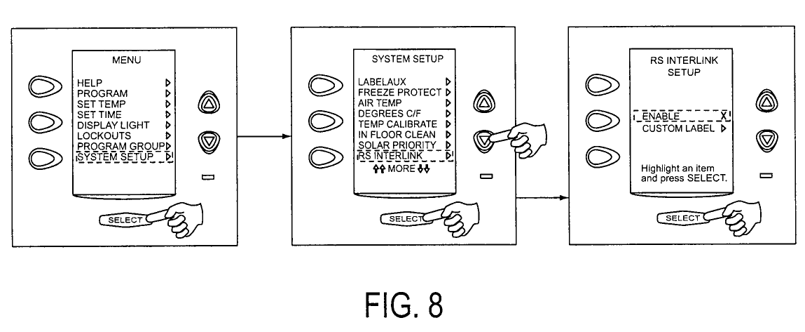

Various methods may be envisioned for installation, setup and/or operation of a residential environmental management control system as described herein. For example, as illustrated in FIG. 8, the interlink may be enabled for each master control it interconnects through a series of menus provided by the common user interface. From an initial “MENU,” a user may access “SYSTEM SETUP” via the common user interface. This may be accomplished by scrolling up/down to highlight “SYSTEM SETUP” and then pressing a “SELECT” button. In addition to other settings, the resulting “SYSTEM SETUP” menu may provide an “RS INTERLINK” or other identifier for the interlink, which may be selected in a similar manner. The resulting “RS INTERLINK SETUP” menu may provide an “ENABLE” option when the interlink is disabled and a “DISABLE” option (not shown) when the interlink is already enabled.

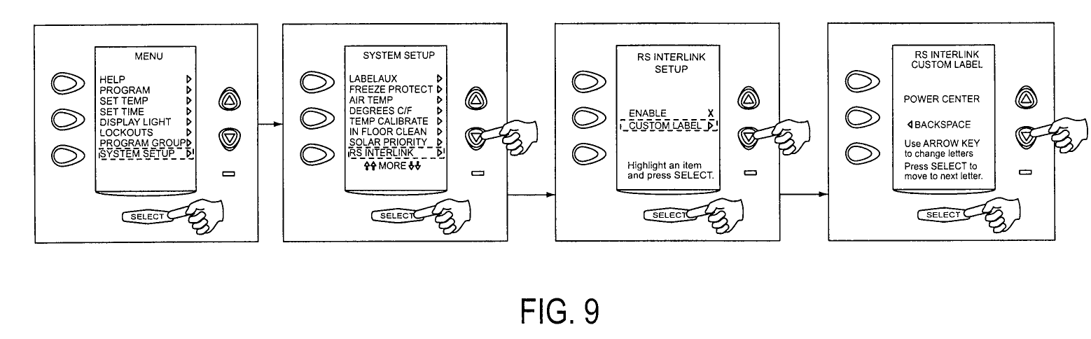

Once the interlink is enabled, the user may have the option to label the interlink following the menus illustrated in FIG. 9, for example. As illustrated, the user may be allowed to enter an alphabetical name, although number and/or symbols are not excluded. This may be advantageous, for example, for a system in which a plurality of interlinks are installed or are to be installed.

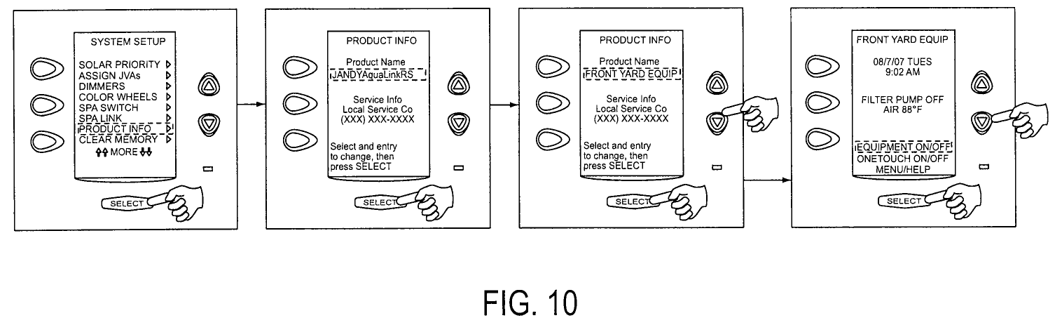

Additionally, the user may have the option to label the individual master controls following the menus illustrated in FIG. 10, for example. From a main “SYSTEM SETUP” menu, a user may select a “PRODUCT INFO” option or other identifier for the master controller to be named. Once the default name, such as “JANDY AquaLinkRS,” is displayed and highlighted, a user may press the “SELECT” button and enter a desired name, as described above, for example. Once the master controller is labeled, such as “FRONT YARD EQUIP” to identify the systems controlled and/or logical division, the label may be displayed to identify the control menu displayed for operation, such as illustrated in the last display of FIG. 10. This label may thus be used in all instances to identify the master control being selected and/or operated.

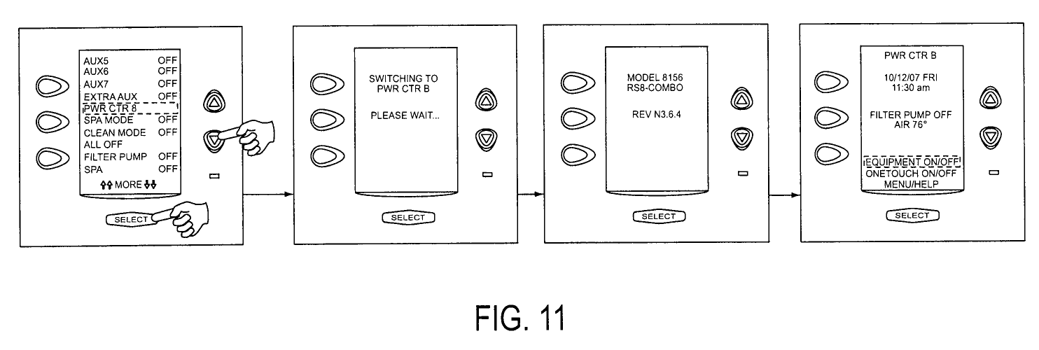

For example, as illustrated in FIG. 11, one of the master controls may be labeled “PWR CTR B”. Once selected, various displays may be provided to the user to confirm selection of the particular master control, provide model information, provide software version information, and the like, before displaying the operation menu for the selected master control, including its label, options for operation and/or status information, as appropriate or desired.

It should be understood that the menu system described above with respect to FIGS. 8-11 is only an example. However, it should also be understood that the menu system provided by the common user interface for setup and operation of the interlink and plural master controls may be intuitive and familiar to a user of the menu system for setup and control of a single master control. Thus, the expansion of a residential environmental management control system using an interlink and a plurality of master controls may not only facilitate such expansion in an economical and competitive manner, but may also allow the user to retain familiarity, comfort and ease of user even with a more complex expanded system.

Although the present disclosure invention has been provided with reference to specific embodiments, persons skilled in the art will recognize that changes may be made in form and detail without departing from the spirit and scope of the disclosure.

What is claimed is:

1. A residential environmental management control system, comprising:
a first master control configured to control operation of a first plurality of residential environmental systems;
a second master control configured to control a second plurality of residential environmental systems;
a common user interface; and
an interlink configured to provide selective communication between the common user interface and the first master control and the second master control.

2. The system of claim 1, further comprising a first master control housing, wherein the interlink is mounted to the first master control housing.

3. The system of claim 2, wherein the interlink is mounted in a same area of the housing as the first master control.

4. The system of claim 2, wherein the first master control housing is configured to provide electrical shielding for the mounted interlink.

5. The system of claim 1, wherein the interlink includes a switch configured to selectively provide communication between a first interface coupled to the common user interface and second and third interfaces respectively coupled to the first and second master controls.

6. The system of claim 5, wherein the switch comprises a manual switch.

7. The system of claim 5, wherein the interlink further includes a first status indicator corresponding to the second interface and a second status indicator corresponding to the third interface.

8. The system of claim 7, wherein the first and second status indicators are each configured to indicate at least one of operation of the respective interface, operation of the respective master control, and selection of the respective interface/master control.

9. An interlink for a residential environmental management control system, the interlink comprising:
a first interface configured to provide communication with a first residential environmental system control;
a second interface configured to provide communication with a second residential environmental system control; and
a third interface configured to provide communication with a common user interface such that the interlink provides selective communication between the common user interface and the first and second residential environmental system controls.

10. The interlink of claim 9, wherein the third interface comprises a receiver configured to provide wireless communication with the common user interface.

11. The interlink of claim 9, wherein the third interface comprises a transceiver configured to provide wireless communication between the common user interface and the interlink.

12. The interlink of claim 9, wherein the first interface comprises an electrical connector.

13. The interlink of claim 9, wherein at least one of the first interface and the second interface comprises a receiver configured to provide wireless communication with the respective residential environmental system control.

14. The interlink of claim 9, wherein at least one of the first interface and the second interface comprises a transceiver configured to provide wireless communication between the respective residential environmental system control and the interlink.

15. The interlink of claim 9, further comprising a switch configured to selectively provide communication between the third interface and the first and second interfaces.

16. The interlink of claim 15, wherein the switch comprises a manual switch.

17. The interlink of claim 16, wherein the interlink further includes a first status indicator corresponding to the second interface and a second status indicator corresponding to the third interface.

18. A method of operating a plurality of residential environmental system master controls, the method comprising:
selecting between a first residential environmental master control and a second residential environmental master control using a common user interface; and
communicating with the selected residential environmental master control using the common user interface to operate the selected environmental master control.

19. The method of claim 17, wherein communicating with the selected residential environmental master control comprises programming the selected environmental master control.

20. The method of claim 18, wherein selecting and communicating are performed via an interlink that provides selective communication between the common user interface and the first and second residential environmental master controls.

21. The method of claim 20, wherein communicating with the selected residential environmental master control using the common user interface comprises wirelessly communicating from the common user interface to the interlink.

22. The method of claim 20, wherein communicating with the selected residential environmental master control using the common user interface comprises wirelessly communicating from the interlink to the selected residential environmental master control.

23. A method of providing communication with a plurality of residential environmental master controls and a common user interface, the method comprising:
providing a first residential environmental master control, a second residential environmental master control, a common user interface and an interlink; and
establishing communication links between the first residential environmental master control and the interlink, between the second mater controller and the interlink, and between the common user interface and the interlink.
